(19) United States
(12) Patent Application Publication
(10) Pub. No.: US 2025/0361109 A1
(43) Pub. Date: Nov. 27, 2025

(54) GLASS EDGE FOILER APPARATUS AND METHODS OF USING THE SAME

(71) Applicant: Creator's Stained Glass, Inc., Spring Grove, IL (US)

(72) Inventor: James Grace, Round Lake Beach, IL (US)

(21) Appl. No.: 18/673,726

(22) Filed: May 24, 2024

(51) Int. Cl. B65H 35/00; B44C 5/08

(52) U.S. Cl. CPC B65H 35/002; B44C 5/08; B65H 2701/173

(57) ABSTRACT

A glass edge foiler apparatus comprises a foil track and dispenser unit configured to allow application of foil tape to an edge or edges of a piece of glass, such as glass that may be utilized for stained glass-containing products. A foil tape dispenser supplies foil tape to a foil track module allowing for different widths of foil tape to be applied to an edge or edges of a glass piece. Methods of using the same are further provided.

### TECHNICAL FIELD

The present invention relates to a glass edge foiler apparatus. Specifically, the glass edge foiler apparatus comprises a foil track and dispenser unit configured to allow application of foil tape to an edge or edges of a piece of glass, such as glass that may be utilized for stained glass-containing products. A foil tape dispenser supplies foil tape to a foil track module allowing for different widths of foil tape to be applied to an edge or edges of a glass piece. Methods of using the same are further provided.

### BACKGROUND

Stained glass windows are made from several pieces of glass, typically colored glass, that are soldered together to form a full structure. Because solder does not stick to glass, copper foil is applied to the edges of the glass piece and adhered thereto. Typically, a strip of copper foil having adhesive on one side is applied to the edges of the glass pieces. The foil is then crimped and burnished so that the copper foil lays flat and smooth on the edges of the glass pieces.

It is often difficult to precisely apply foil to the edge of a glass piece. Because the foil is very thin, the foil can easily tear upon application. Moreover, if applied incorrectly, the foil may not adhere properly to the glass and may come off. A need, therefore, exists for an improved glass edge foiler apparatus. Specifically, a need exists for an improved glass edge foiler that prevents or reduces the incidence of tearing of foil when applied to edges of a glass piece. Moreover, a need exists for an improved glass edge foiler apparatus that may allow a user to precisely apply the foil to the edges of the glass, thereby ensuring that the foil is placed and adheres properly to the edges of the glass piece.

In addition, there are different widths of foil that may be used on glass pieces, often because there are different widths of glass pieces that may be used in stain glass making. Foil edge applicators often only provide application of only one size of foil to glass edges. It is therefore common to have many different foil applicators so that several different widths of foil can be applied to various widths of glass pieces. A need, therefore, exists for an improved glass foiler apparatus that allows different widths of foil to be applied to glass edges. Moreover, a need exists for an improved glass foiler that accommodates different widths of glass pieces.

Handheld glass foilers are often difficult to use to provide consistent foiling of glass piece edges. It is often difficult to manually hold the foilers steady and aligned with glass edges during application thereof. Foiling the edges of glass often requires very steady hands and visual acuity, both of which become difficult as a person ages. Specifically, handheld glass foilers can often lead to misalignment and unsightly application of the foil to the glass edges. A need, therefore, exists for an improved glass edge foiler apparatus that allows a user to consistently align foil to edges of glass in precisely desired locations. Moreover, a need exists for an improved glass edge foiler apparatus that provides consistently sightly application of foil to glass edges.

### SUMMARY OF THE INVENTION

The present invention relates to a glass edge foiler apparatus. Specifically, the glass edge foiler apparatus comprises a foil track and dispenser unit configured to allow application of foil tape to an edge or edges of a piece of glass, such as glass that may be utilized for stained glass-containing products. A foil tape dispenser supplies foil tape to a foil track module allowing for different widths of foil tape to be applied to an edge or edges of a glass piece. Methods of using the same are further provided.

To this end, in an embodiment of the present invention, a glass edge foiler apparatus is provided. The glass edge foiler apparatus comprises: a base; a foil tape roll holder configured to hold a roll of foil tape, the foil tape having a non-adhesive side, an adhesive side, and a backing thereon; a pressure applicator module comprising first and second legs extending vertically from the base, wherein the pair of legs are configured to flex away from each other; a first horizontally disposed arm extending from the first leg and a second horizontally disposed arm extending from the second leg, wherein the first horizontally disposed arm and the second horizontally disposed arm form a space configured to receive a plate of glass; a foil track module having a first track beneath the first and second arms configured to receive foil tape from the roll of foil tape in the foil tape roll holder, wherein the first and second arms are configured to maintain an edge of the plate of glass in alignment adjacent the adhesive side of the foil tape.

In an embodiment, the glass edge foiler apparatus further comprises: a first tower extending adjacent the foil tape roll holder having a top surface configured to allow the non-adhesive side of the foil tape to travel thereover.

In an embodiment, the glass edge foiler apparatus further comprises: a foil tape backing splitter disposed over the top surface of the first tower, wherein the foil tape backing splitter is configured to separate the backing from the adhesive side of the foil tape when the foil tape travels over the top surface of the first tower.

In an embodiment, the foil tape backing splitter is rotatable from a first position adjacent to the top surface of the first tower to a second position over the top surface of the first tower.

In an embodiment, the foil tape roll holder is configured to hold rolls of foil tape having different widths.

In an embodiment, the glass edge foiler apparatus further comprises: a latch configured to rotate from an unlatched position and a latched position, such that when the latch is in the latched position, it is configured to hold the roll of foil tape within the foil tape roll holder.

In an embodiment, the first arm comprises a first roller and the second arm comprises a second roller, wherein the first roller and the second roller are configured to roll against the glass plate when the glass plate is pushed between the first arm and the second arm.

In an embodiment, the first track comprises a roller.

In an embodiment, the foil track module comprises a second track, wherein the first track and the second track are individually selectable.

In an embodiment, the first track comprises a first roller and the second track comprises a second roller.

In an embodiment, the foil track module comprises a third track, wherein the first track, the second track, and the third track and individually selectable.

In an embodiment, the first track comprises a first roller, the second track comprises a second roller, and the third track comprises a third roller.

In an embodiment, the first track and the second track are disposed on a laterally-moving tower extension, wherein the tower extension is configured to move laterally between a first position and a second position, wherein when the tower extension is in the first position, the first track is disposed beneath the first and second arms and further wherein when the tower extension is in the second position, the second track is disposed beneath the first and second arms.

In an embodiment, the first track has a first width and the second track has a second width, wherein the first width and the second width are different.

In an embodiment, the glass edge foiler apparatus further comprises: an arrow indicator extending from the laterally-moving tower extension, wherein the arrow indicator points to first indicia or second indicia informing a user of the selection of the first track or the second track when the user selects the first track or the second track, respectively.

In an embodiment, the indicia indicates the width size of the foil tape accommodated by the first track and the second track, respectively.

In an embodiment, the glass edge foiler apparatus further comprises: a first magnet embedded in a bottom surface of the laterally-moving tower extension; a second magnet embedded in the base, wherein the first magnet embedded in the bottom surface of the laterally-moving tower extension magnetically mates with the second magnet embedded in the base when the laterally-moving tower extension is moved into the first position; and a third magnet embedded in the base, wherein the first magnet embedded in the bottom surface of the laterally-moving tower extension magnetically mates with the third magnet embedded in the base when the laterally-moving tower extension is moved into the second position.

In an embodiment, the first track, the second track, and the third track are disposed on a laterally-moving tower extension, wherein the laterally-moving tower extension is configured to move laterally between a first position, a second position, and a third position, wherein when the tower extension is in the first position, the first track is disposed beneath the first and second arms and wherein when the tower extension is in the second position, the second track is disposed beneath the first and second arms, and further wherein when the tower extension is in the third position, the third track is disposed beneath the first and second arms.

In an embodiment, the first track, the second track, and the third track each have different widths to accommodate a first foil tape having a first width, a second foil tape having a second width, and a third foil tape having a third width respectively.

In an embodiment, the glass edge foiler apparatus further comprises: a first magnet embedded in a bottom surface of the laterally-moving tower extension; a second magnet embedded in the base, wherein the first magnet embedded in the bottom surface of the laterally-moving tower extension magnetically mates with the second magnet embedded in the base when the laterally-moving tower extension is moved into the first position; a third magnet embedded in the base, wherein the first magnet embedded in the bottom surface of the laterally-moving tower extension magnetically mates with the third magnet embedded in the base when the laterally-moving tower extension is moved into the second position; and a fourth magnet embedded in the base, wherein the first magnet embedded in the bottom surface of the laterally-moving tower extension magnetically mates with the fourth magnet embedded in the base when the laterally moving tower extension is moved into the third position.

It is, therefore, an advantage and objective of the present invention to provide an improved glass edge foiler apparatus.

Specifically, it is an advantage and objective of the present invention to provide an improved glass edge foiler that prevents or reduces the incidence of tearing of foil when applied to edges of a glass piece.

Moreover, it is an advantage and objective of the present invention to provide an improved glass edge foiler apparatus that may allow a user to precisely apply the foil to the edges of the glass, thereby ensuring that the foil is placed and adheres properly to the edges of the glass piece.

In addition, it is an advantage and objective of the present invention to provide an improved glass foiler apparatus that allows different widths of foil to be applied to glass edges.

Moreover, it is an advantage and objective of the present invention to provide an improved glass foiler that accommodates different widths of glass pieces.

Further, it is an advantage and objective of the present invention to provide an improved glass edge foiler apparatus that allows a user to consistently align foil to edges of glass in precisely desired locations.

Still further, it is an advantage and objective of the present invention to provide an improved glass edge foiler apparatus that provides consistently sightly application of foil to glass edges.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a glass edge foiler apparatus in an embodiment of the present invention.

FIG. 2 illustrates a close-up view of a glass edge foiler apparatus in an embodiment of the present invention.

FIG. 3 illustrates a further close-up view of a glass edge foiler apparatus in an embodiment of the present invention.

FIG. 4 illustrates a raised perspective view of a glass edge foiler apparatus in an embodiment of the present invention.

FIG. 5 illustrates a further raised perspective view of a glass edge foiler apparatus in an embodiment of the present invention.

FIG. 6 illustrates a front view of a glass edge foiler apparatus in an embodiment of the present invention.

FIG. 7 illustrates a further front view of a glass edge foiler apparatus in an embodiment of the present invention.

FIG. 8 illustrates yet another front view of a glass edge foiler apparatus in an embodiment of the present invention.

### DETAILED DESCRIPTION OF THE PRESENTLY PREFERRED EMBODIMENTS

The present invention relates to a glass edge foiler apparatus. Specifically, the glass edge foiler apparatus comprises a foil track and dispenser unit configured to allow application of foil tape to an edge or edges of a piece of glass, such as glass that may be utilized for stained glass-containing products. A foil tape dispenser supplies foil tape to a foil track module allowing for different widths of foil tape to be applied to an edge or edges of a glass piece. Methods of using the same are further provided.

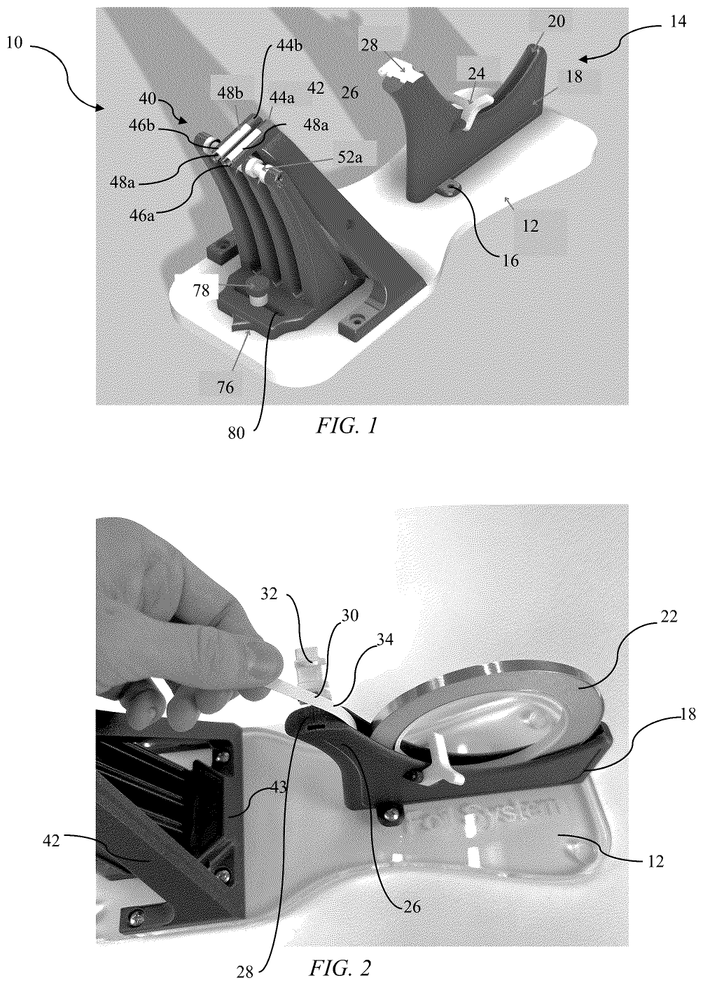

Referring now to the drawings, FIG. 1 illustrates a glass edge foiler apparatus 10 in an embodiment of the present invention. The glass edge foiler apparatus 10 has a flat base 12 upon which is disposed a foil roll holder 14 configured to hold a roll of copper foil for dispensing foil therefrom, as shown in FIGS. 2-5. The foil roll holder 14 may comprise one or more tabs 16 having apertures for receiving screws, bolts, or other connections for connecting and rigidly holding the foil roll holder 14 to the flat base 12.

The foil roll holder 14 may comprise a housing 18 having an arcuately-shaped slit 20 in which a roll of copper foil 22 may sit, as shown in FIG. 2. When disposed within the arcuately-shaped slit 20, the roll of copper foil 22 may be held in place with a rotatable locking latch 24, thereby preventing the roll of copper foil 22 from existing the slit 20. Further, the slit may have variable levels (not shown) on sidewalls therein that allow rolls of copper foil of various thicknesses to be disposed therein and held in place. The levels may frictionally hold the roll of copper foil 22 in place, preventing side-to-side movement thereof during use.

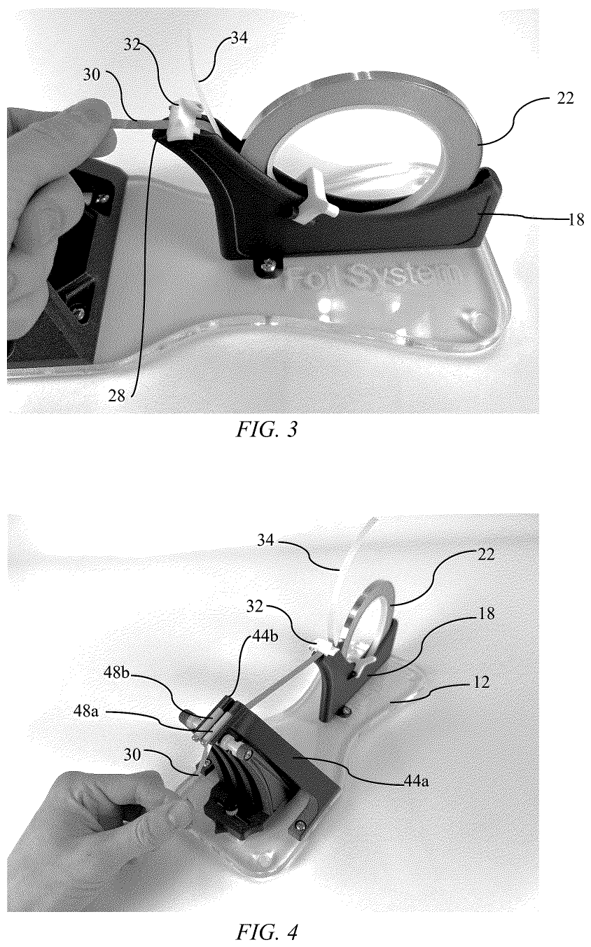

A tower 26 having a flat top surface 28 may extend from a front of the housing 18 over which copper foil tape 30 dispensed from the roll of copper foil 22 may be pulled. A rotatable foil splitter 32 may be placed over the foil tape 30 when disposed over the flat top surface 28 to hold the foil tape 30 in place and align the foil tape 30 with a foil track module 40, as described in more detail below. As illustrated in FIG. 3, the copper foil tape 30 may have an adhesive thereon and an adhesive paper backing 34 which may be removed from the foil tape 30 when disposed over the flat top surface 28. The rotatable foil splitter 32 may rotate to cover the flat top surface 28 and be placed over the foil tape 30 and provide a ramped surface 36 that may operate to remove the adhesive backing 34 from the foil tape 30 when the foil tape 30 is pulled over the flat top surface 28. The foil tape 30, without the adhesive backing 34, may thus extend from the flat top surface 28 to the foil track module 40.

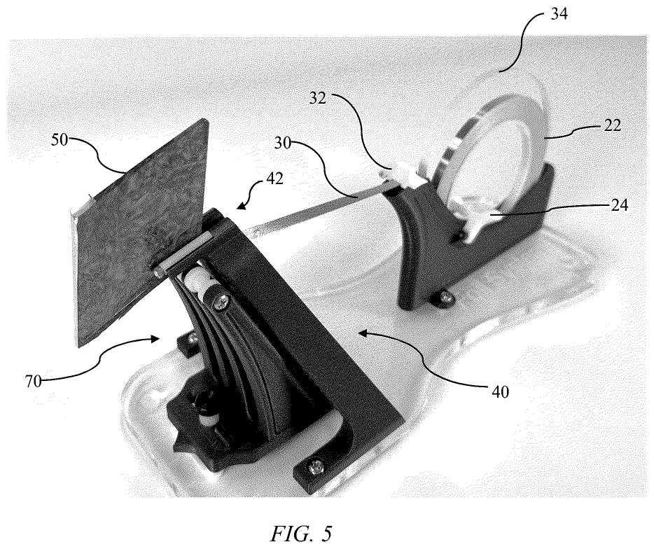

The foil track module 40 comprises a pressure applicator module 42 having a pair of flexible legs 44a, 44b, each having an arm 46a, 46b, respectively extending horizontally therefrom. The arms 46a, 46b each have rollers 48a, 48b aiding a glass plate 50, as illustrated in FIG. 5 to be disposed therebetween. Therefore, any glass plate 50 may be disposed between the arms 46a, 46b and frictionally held therein by tension applied thereto by the legs 44a, 44b, which may operate as leaf springs, spreading to accept the glass plate 50 and applying tension to the glass plate 50 thereby holding the glass plate 50 in precise alignment for application of the foil tape 30 to edges thereof, as shown in FIG. 5.

The foil tape 30 may be held in place beneath the arms 44a, 44b so that the foil tape 30 may be applied to the edges of the glass plate 50. Specifically, to hold the foil tape 30 for adhering to edges of the glass plate 50, the foil track module 40 may have one or more tracks thereon for holding the foil tape 30 in a precise position beneath the arms 48a, 48b so that the edges of the glass plate 50 disposed between the arms 48a, 48b may receive the adhesive side of the foil tape. Specifically, once the foil tape 30 is dispensed from the roll of foil 22 and dispensed over the flat top surface 28, the foil tape 30, without the adhesive paper backing 34, may be disposed beneath the arms 44a, 44b and onto one of a plurality of roller spacers 52a, 52b, 52c that may have a rolling surface size that is the same or similar width as the foil tape 30. The roller spacers 52a, 52b, 52c may form the one or more tracks for holding the foil tape 30 in precise positions.

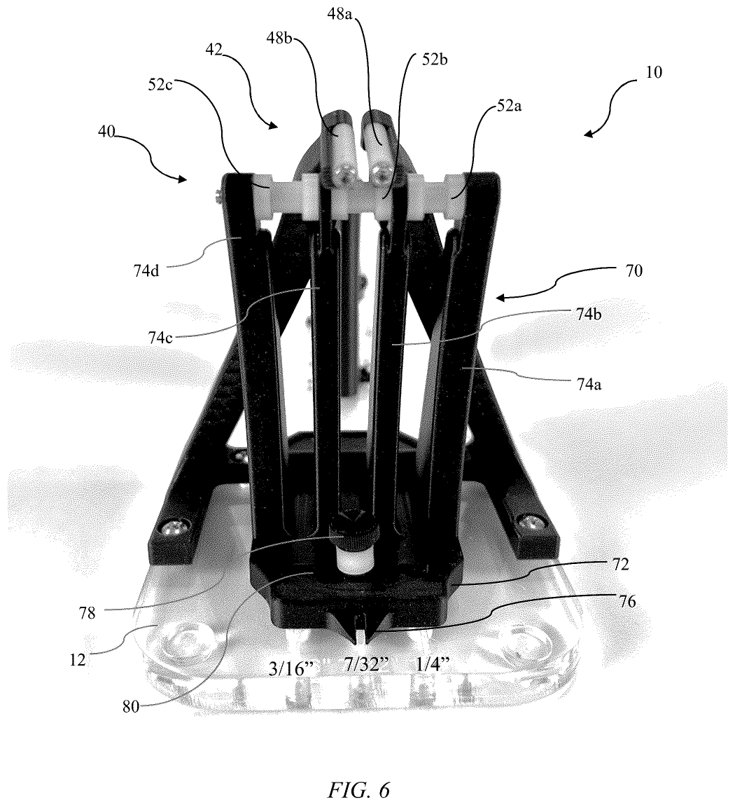

As illustrated in FIGS. 6-8, the foil track module 40 may further comprise a laterally-movable vertically-disposed tower extension 70 having a base 72 connected to the base 12 of the apparatus 10 and further having a plurality of upwardly disposed legs 74a, 74b, 74c, 74c, between which the roller spacers 52a, 52b, 52c may bridge at or near the top terminal end of each, respectively. Specifically, roller spacer 52a may bridge between legs 74a, 74b; roller spacer 52b may bridge between legs 74b, 74c; and roller spacer 52c may bridge between legs 74c, 74d. Each roller spacer 52a, 52b, 52c may have a different width to accommodate a different width, respectively, of foil tape that may used in the apparatus 10. For example, roller spacer 52a may accommodate 3/16″ wide copper foil; roller spacer 52b may accommodate 7/32″ wide copper foil; and roller spacer 52c may accommodate ¼″ wide copper foil. These widths represent the most common copper foil widths that may be used in foiling glass edges for use in stained glass making. However, any other sized roller spacer may be utilized therein and the present invention should not be limited as described herein. The roller spacers 52a, 52b, 52c are sized to hold the foil tape in place when adhering to an edge of a glass plate 50, without moving laterally so that the foil is applied to the edges of the glass plate 50 more precisely.

The tower extension 70 may further have a rear wedge element (not shown) that may be disposed beneath a base 43 of the pressure applicator module 42 (illustrated in FIG. 2) that may further hold the tower 70 in place, thereby preventing the same from lifting from the base 12 of the apparatus 10. However, the rear wedge element may not restrict the lateral movement of the tower 70, as further described below.

The tower extension 70 may be movable laterally so as to align the various roller spacers 52a, 52b, or 52c with the pressure applicator module 42 to accommodate the different sized copper foils. As illustrated in FIG. 6, roller spacer 52b may be aligned with the pressure applicator module 42 to accommodate copper foil tape having a width of 7/32″. An arrow indicator 76 may extend from the base 72 of the tower 70 to point to indicia that informs a user the size of the copper foil accommodated by the roller space selected. As shown in FIG. 6, the arrow indicator 76 may inform a user that a 7/32″ copper foil may be accommodated using roller spacer 52b.

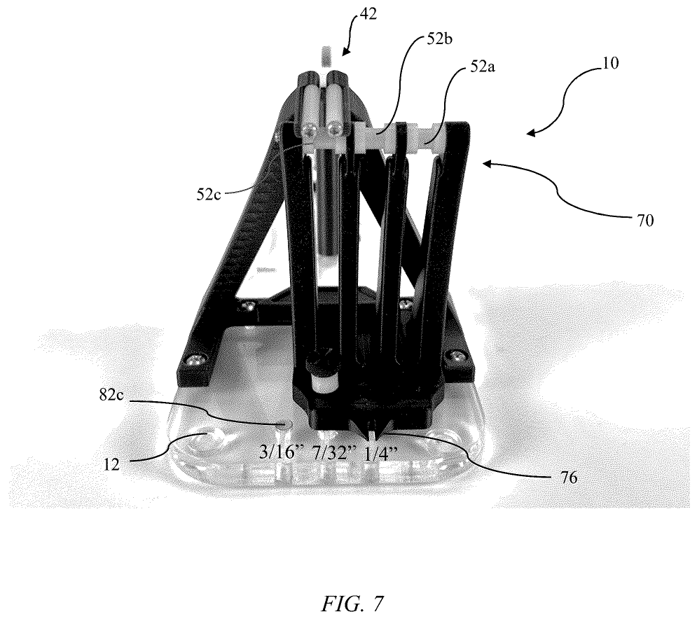

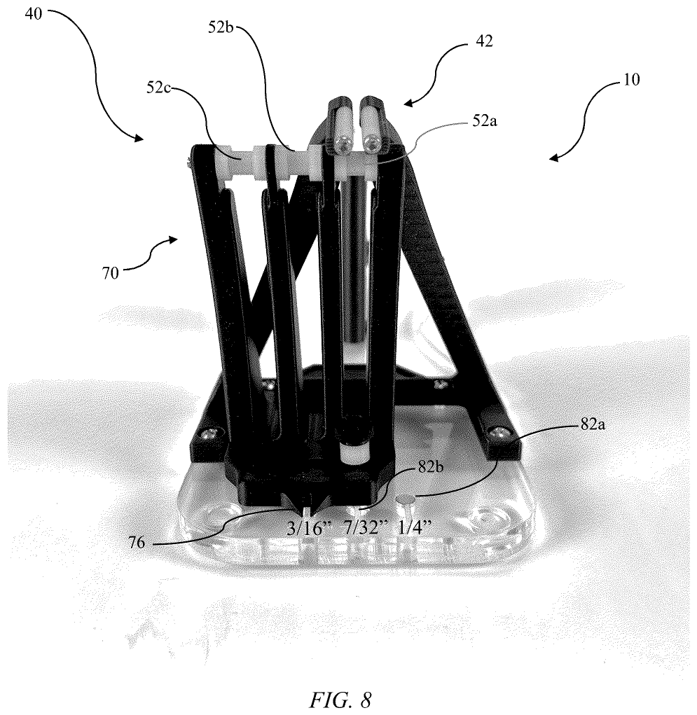

As illustrated in FIG. 7, the tower 70 may move laterally to the right (when looking at the apparatus 10 from the front thereof as shown in FIG. 7), which may align the left-most roller spacer 52c with the pressure applicator module 42 and the arrow indicator 76 may move to the right with the tower 70 to point to the indicia on the base 12 that indicates the width of the copper foil accommodated by the roller spacer 52c, which, in this case, is ¼″ wide copper foil. Likewise, as illustrated in FIG. 8, the tower 70 may move laterally to the left (when looking at the apparatus 10 from the front thereof as shown in FIG. 8), which may align the right most roller spacer 52a with the pressure applicator 42 and the arrow indicator 76 may move to the left with the tower 70 to point to the indicia on the base 12 that indicates the width of the copper foil accommodated by the roller spacer 52a, which, in this case, is 3/16″ wide copper foil.

The tower 70 may move laterally, as described above, and held in place when in the desired position through a thumb screw 78 having a post (not shown) that travels through a laterally-disposed slot 80 within the base 72 of the tower 70 and into the base 12 of the apparatus 10, providing a track for the tower 70 to move laterally. The thumb screw 78 may be loosened for moving the tower 70 laterally and may be tightened onto the base 72 of the tower 70 when the tower is in the desired positioned, thereby locking the tower into the desired position.

A magnet (not shown) embedded in a bottom surface of the base 72 of the tower 70 may align with mating magnets 82a, 82b, 82c embedded within the base 12 of the apparatus 10 to aid a user in precisely aligning the tower 70 so that the desired roller spacer 52a, 52b, or 52c may be aligned with the pressure applicator module 42. Therefore, when a user wishes to align the center roller spacer 52b, the user may loosen the thumb screw 78 and move the tower 70 so that the roller spacer 52b aligns with the pressure applicator module 42.

When aligned, the magnet in the base 72 of the tower 70 may magnetically lock with the center magnet 82b within the base 12 of the apparatus 10 so that a user may be assured that the roller spacer 52b is properly aligned. Likewise, when the tower 70 is moved to the right (when looking to the front thereof), the magnet 82a may magnetically lock with the magnet embedded in the base 72 of the tower 70 thereby precisely aligning the roller spacer 52c with the pressure applicator module 42. And finally, when the tower 70 is moved to the left (when looking to the front thereof), the magnet 82c may magnetically lock with the magnet embedded in the base 72 of the tower 70 thereby precisely aligning the roller spacer 52a with the pressure applicator module 42. Once aligned, the thumb screw 78 may be turned to tighten onto the base 72 of the tower 70, thereby further locking the tower into place for use thereof, as described above.

In use, foil tape 30 may be pulled over top surface 28 of tower 26, while the splitter element 32 may remove the adhesive backing 34 from the foil tape 30. The foil tape, having the adhesive side up, may further be placed within one of the roller spacers 52a, 52b, 52c, as needed based on the width of the foil 30 used and aligned as described above so that the foil tape 30 rests on the roller spacer 52a, 52b, or 52c. The glass plate 50 may be pressed downwardly through the arms 46a, 46b, which may spread under tension. Rollers 48a, 48b may aid in the movement of the glass plate 50 past the arms 46a, 46b until an edge of the glass plate rests upon the adhesive side of the foil tape 30. The glass plate 50 may then be moved thereby adhering the foil tape 30 to the edge of the glass plate 50 while simultaneously pulling foil tape 30 from the roll of foil tape 22. The glass plate 50 may be moved and rotated, adhering the foil tape 30 thereto until all edges of the glass plate 50 have foil adhered thereto. The glass plate 50 may be removed from between the arms 46a, 46b. Optionally, a tab or wedge (not shown) may be placed between the arms 46a, 46b to open the arms 46a, 46b wider than the glass plate 50 so that the glass plate 50 may be removed from between the arms 46a, 46b without accidentally crimping the foil tape 30 to the glass plate 50. Once removed, the foil tape 30 may be crimped onto the glass plate and burnished.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

What is claimed is:

1. A glass edge foiler apparatus comprising:
a base;
a foil tape roll holder configured to hold a roll of foil tape, the foil tape having a non-adhesive side, an adhesive side, and a backing thereon;
a pressure applicator module comprising first and second legs extending vertically from the base, wherein the pair of legs are configured to flex away from each other;
a first horizontally disposed arm extending from the first leg and a second horizontally disposed arm extending from the second leg, wherein the first horizontally disposed arm and the second horizontally disposed arm form a space configured to receive a plate of glass;
a foil track module having a first track beneath the first and second arms configured to receive foil tape from the roll of foil tape in the foil tape roll holder,
wherein the first and second arms are configured to maintain an edge of the plate of glass in alignment adjacent the adhesive side of the foil tape.

2. The glass edge foiler apparatus of claim 1 further comprising:
a first tower extending adjacent the foil tape roll holder having a top surface configured to allow the non-adhesive side of the foil tape to travel thereover.

3. The glass edge foiler apparatus of claim 2 further comprising:
a foil tape backing splitter disposed over the top surface of the first tower, wherein the foil tape backing splitter is configured to separate the backing from the adhesive side of the foil tape when the foil tape travels over the top surface of the first tower.

4. The glass edge foiler apparatus of claim 3 wherein the foil tape backing splitter is rotatable from a first position adjacent the top surface of the first tower to a second position over the top surface of the first tower.

5. The glass edge foiler apparatus of claim 1 wherein the foil tape roll holder is configured to hold rolls of foil tape having different widths.

6. The glass edge foiler apparatus of claim 1 further comprising:
a latch configured to rotate from an unlatched position and a latched position, such that when the latch is in the latched position, it is configured to hold the roll of foil tape within the foil tape roll holder.

7. The glass edge foiler apparatus of claim 1 wherein the first arm comprises a first roller and the second arm comprises a second roller, wherein the first roller and the second roller are configured to roll against the glass plate when the glass plate is pushed between the first arm and the second arm.

8. The glass edge foiler apparatus of claim 1 wherein the first track comprises a roller.

9. The glass edge foiler apparatus of claim 1 wherein the foil track module comprises a second track, wherein the first track and the second track are individually selectable.

10. The glass edge foiler apparatus of claim 9 wherein the first track comprises a first roller and the second track comprises a second roller.

11. The glass edge foiler apparatus of claim 9 wherein the foil track module comprises a third track, wherein the first track, the second track, and the third track and individually selectable.

12. The glass edge foiler apparatus of claim 11 wherein the first track comprises a first roller, the second track comprises a second roller, and the third track comprises a third roller.

13. The glass edge foiler apparatus of claim 9 wherein the first track and the second track are disposed on a laterally-moving tower extension, wherein the tower extension is configured to move laterally between a first position and a second position, wherein when the tower extension is in the first position, the first track is disposed beneath the first and second arms and further wherein when the tower extension is in the second position, the second track is disposed beneath the first and second arms.

14. The glass edge foiler apparatus of claim 9 wherein the first track has a first width and the second track has a second width, wherein the first width and the second width are different.

15. The glass edge foiler apparatus of claim 13 further comprising:
an arrow indicator extending from the laterally-moving tower extension, wherein the arrow indicator points to first indicia or second indicia informing a user of the selection of the first track or the second track when the user selects the first track or the second track, respectively.

16. The glass edge foiler apparatus of claim 15 wherein the indicia indicates the width size of the foil tape accommodated by the first track and the second track, respectively.

17. The glass edge foiler apparatus of claim 13 further comprising:
a first magnet embedded in a bottom surface of the laterally-moving tower extension;
a second magnet embedded in the base, wherein the first magnet embedded in the bottom surface of the laterally-moving tower extension magnetically mates with the second magnet embedded in the base when the laterally-moving tower extension is moved into the first position; and
a third magnet embedded in the base, wherein the first magnet embedded in the bottom surface of the laterally-moving tower extension magnetically mates with the third magnet embedded in the base when the laterally-moving tower extension is moved into the second position.

18. The glass edge foiler apparatus of claim 11 wherein the first track, the second track, and the third track are disposed on a laterally-moving tower extension, wherein the laterally-moving tower extension is configured to move laterally between a first position, a second position, and a third position, wherein when the tower extension is in the first position, the first track is disposed beneath the first and second arms and wherein when the tower extension is in the second position, the second track is disposed beneath the first and second arms, and further wherein when the tower extension is in the third position, the third track is disposed beneath the first and second arms.

19. The glass edge foiler apparatus of claim 11 wherein the first track, the second track, and the third track each have different widths to accommodate a first foil tape having a first width, a second foil tape having a second width, and a third foil tape having a third width respectively.

20. The glass edge foiler apparatus of claim 18 further comprising:
a first magnet embedded in a bottom surface of the laterally-moving tower extension;
a second magnet embedded in the base, wherein the first magnet embedded in the bottom surface of the laterally-moving tower extension magnetically mates with the second magnet embedded in the base when the laterally-moving tower extension is moved into the first position;
a third magnet embedded in the base, wherein the first magnet embedded in the bottom surface of the laterally-moving tower extension magnetically mates with the third magnet embedded in the base when the laterally-moving tower extension is moved into the second position; and
a fourth magnet embedded in the base, wherein the first magnet embedded in the bottom surface of the laterally-moving tower extension magnetically mates with the fourth magnet embedded in the base when the laterally moving tower extension is moved into the third position.
